(19) United States
(12) Patent Application Publication
(10) Pub. No.: US 2022/0234665 A1
(43) Pub. Date: Jul. 28, 2022

(54) FREE-MOVING TRANSPORT CART, CONVEYING SYSTEM AND TREATMENT PLANT

(71) Applicant: EISENMANN GMBH, Böblingen (DE)

(72) Inventor: Herbert Schulze, Aidlingen (DE)

(21) Appl. No.: 17/612,637

(22) PCT Filed: Apr. 30, 2020
(86) PCT No.: PCT/EP2020/062125

§ 371 Date: Nov. 19, 2021

(30) Foreign Application Priority Data
May 22, 2019 (DE) 10 2019 113 637.7

(51) Int. Cl. B62D 65/18; B60P 3/06

(52) U.S. Cl. CPC B62D 65/18; B60P 3/06

(57) ABSTRACT

A free-moving transport cart for conveying workpieces, in particular vehicle bodies, on a conveying path, having a chassis which defines a main axis- and main orientation of the transport cart and having a chassis frame which supports a plurality, in particular at least four, wheel arrangements each having one or more wheels. A fastening device for at least one workpiece is coupled to the chassis by a connecting device. There is a wheel guide system for the wheels of the wheel arrangements which defines a basic chassis configuration in which the wheel arrangements define a horizontal travel plane. The wheel guide system guides the wheels of the wheel arrangements in such a way that at least one wheel of at least one wheel arrangement can be moved out of the travel plane without the other wheel arrangements completely leaving the travel plane. A conveying system has a large number of such transport carts and a treatment plant has such a conveying system.

The invention relates to a free-moving transport cart for conveying workpieces, in particular vehicle bodies, on a conveying line, having
a) a chassis which defines a main axis and main orientation of the transport cart, and comprises a chassis frame which supports a plurality of, in particular at least four, wheel arrangements each having one or more wheels;
b) a fastening device for at least one workpiece, which is coupled to the chassis by means of a connecting device;
c) a wheel guiding system for the wheels of the wheel arrangements, which defines a basic chassis configuration in which the wheel arrangements define a horizontal travel plane.

In addition, the invention relates to a conveying system for conveying workpieces, in particular vehicle bodies, on a conveying line, and to a treatment plant for treating workpieces.

In the case of such treatment plants, one or more treatment devices are arranged along a conveying line which is present, the treatment devices being able to be in particular a coating cabin, a dryer or a workstation. The workpieces here can be treated with materials or media in a treatment device, for example painted, or assembled or else mechanically processed, for example ground or polished, in a workstation. In the case of vehicle bodies, a workstation can be formed in particular by an assembly station in which the body shell is provided with the vehicle components.

The travel plane defined by the transport cart in practice coincides with a horizontally flat travel floor on which the transport cart moves. One or more of the roller arrangements which are present support one or more driven and/or steerable wheels, whereas other wheel arrangements support wheels which rotate only passively and are not driven, but may also be steerable. The main axis of the transport cart is generally the longitudinal axis thereof. The direction of said longitudinal axis generally coincides with the main conveying direction in which the transport cart moves. Even in the case of omnidirectional transport carts which do not always permit an unambiguous assignment of front and rear, a corresponding reference axis can, however, be defined.

In the above-discussed operations, but also generally on the conveying line, for a satisfactory process sequence the workpieces have to follow the conveying line with a high degree of accuracy. In particular in the case of the automated coating of the workpieces with the aid of painting robots, the movement of the workpieces and the movement of the robots are coordinated with one another. If the workpieces deviate too far or too suddenly from a basic path, this can have negative effects on the coating result.

However, also in the case of the manual assembly steps mentioned, the working sequences of the workers are matched to the movement sequence and to the corresponding position and orientation of the workpieces.

During their travel along the conveying line, the workpieces are intended to follow a stable path, and therefore the transport carts are preferably provided with an unsprung wheel guiding system.

An unsprung wheel guiding system is intended to be understood as meaning a system in which no resilient elements with restoring forces can act indirectly or directly on the wheel arrangements or wheels.

However, in the case of such a wheel guiding system, there is the risk, in the event of a floor unevenness, of the transport cart tilting to the side or at least partially, i.e. at least with one of the wheel arrangements, losing the necessary floor contact. In particular if this involves a driven and/or steerable wheel arrangement, the control of the transport cart can then be restricted. This will be explained once again further below in conjunction with FIG. 4.

For a controlled movement of the transport cart and of the workpiece, it is therefore desirable for the continuous floor contact of the wheel arrangements to be ensured and for the workpiece at the same time to be able to be conveyed stably in terms of movement.

It is therefore an object of the invention to provide a transport cart, a conveying system and a treatment plant of the type mentioned at the beginning which take this concept into account.

This object is achieved in the case of a transport cart of the type mentioned at the beginning in that
d) the wheel guiding system guides the wheels of the wheel arrangements in such a manner that at least one wheel of at least one wheel arrangement is movable out of the travel plane without the remaining wheel arrangements completely leaving the travel plane.

In this way, a wheel can evade or, better, can follow a floor unevenness, with the remaining wheels being able to remain in floor contact. The evading wheel likewise remains in floor contact over the floor unevenness. As becomes clear further below, tilting of the workpiece can be at least reduced by such a wheel guiding system when the transport cart travels over a floor unevenness.

It is particularly advantageous if the wheel guiding system comprises at least one swing-axle structure which is mounted on the chassis frame so as to swing about a swing axis and which extends in the direction of the main axis, wherein the swing-axle structure carries a first wheel arrangement on the one side of the swing axis and carries a second wheel arrangement on the other side of the swing axis. By this means, a mechanically relatively simple construction is formed which meets all the desired requirements.

In a preferred variant, the swing axis is arranged centrally between the first and the second wheel arrangement.

Alternatively, it can be favorable if the swing axis is arranged eccentrically between the first and the second wheel arrangement.

Since, if there is only one swing axis, tilting of the transport cart may still occur, the wheel guiding system preferably comprises a first swing-axle structure and a second swing-axle structure which are spaced apart from one another, i.e. are arranged one after the other, in the direction of the main axis.

In this case, it is preferred that the swing axis of the first swing-axle structure and the swing axis of the second swing-axle structure run at least in a common vertical plane, in particular coaxially, in the basic chassis configuration.

Alternatively, it can be favorable if the swing axis of the first swing-axle structure and the swing axis of the second swing-axle structure are offset in a horizontal direction perpendicular to the main axis in the basic chassis configuration. For this purpose, swing-axle structures in which the swing axis is arranged eccentrically between the wheel arrangements are preferably considered here.

It can be of advantage if the wheel guiding system for at least one swing-axle structure which is present comprises a blocking device by means of which a swinging movement of the swing-axle structure about the swing axis is blockable or releasable. This is particularly favorable in the event of two swing-axle structures, the swing axes of which run in a common vertical plane and in particular coaxially.

The blocking device advantageously then comprises a movable blocking element which is movable, in particular in a motorized manner, between a blocking position, in which it blocks a swinging movement of the swing-axle structure, and a release position, in which it releases a swinging movement of the swing-axle structure.

In the case of two swing-axle structures, it is favorable if there is a respective blocking device with a blocking element for the first and the second swing-axle structure, and that the wheel guiding system comprises a safety device which ensures that at least always one blocking element of the two blocking devices takes up its blocking position and blocks the associated swing-axle structure.

In order to even further reduce tilting of the transport cart to the side, it is favorable if, in the case of at least one swing-axle structure, the first wheel arrangement and/or the second wheel arrangement is mounted movably on the swing-axle structure.

Preferably, the movably mounted wheel arrangement comprises a carrying structure which carries or supports one or more wheels and is mounted on the swing-axle structure so as to be pivotable about a pivot axis, wherein the pivot axis runs in particular parallel to the swing axis of the swing-axle structure.

It is particularly advantageous if, in the basic chassis configuration, the pivot axis of the carrying structure is located lower in the vertical direction than the wheel axes of the one or more wheels of the movably mounted wheel arrangement.

It is also favorable if the movably mounted wheel arrangement comprises at least one first and one second wheel which are each mounted separately by means of a bearing structure which is in each case fastened pivotably about a pivot axis to the carrying structure, the bearing structure running in particular parallel to the swing axis of the swing-axle structure and to the pivot axes of the carrying structures of the wheel arrangements.

As discussed above, the wheel guiding system is preferably an unsprung wheel guiding system.

The wheel guiding system is distinguished in particular in that it is configured in such a manner that, within the scope of the possible movement of the at least one wheel or of one of the wheel arrangements out of the travel plane, the transport cart always remains statically determined.

With regard to the conveying system, the abovementioned object is achieved in that the conveying system comprises a multiplicity of transport carts having some or all of the above-explained features.

In the case of the treatment plant, the abovementioned object is achieved in that such a conveying system is present.

Said conveying system is particularly advantageous if along the conveying line there is a travel space for the chassis, which is connected in an upward direction to a conveying space by a connecting passage in such a manner that the chassis is movable in the travel space and the fastening device is carried along in the conveying space, with the connecting device extending through the connecting passage.

Preferably, along the conveying line at least one treatment device is arranged, in particular a dryer, a workstation or a coating device, which comprises a floor and/or a partition with the connecting passage.

Exemplary embodiments of the invention will now be explained in more detail below with reference to the drawings, in which

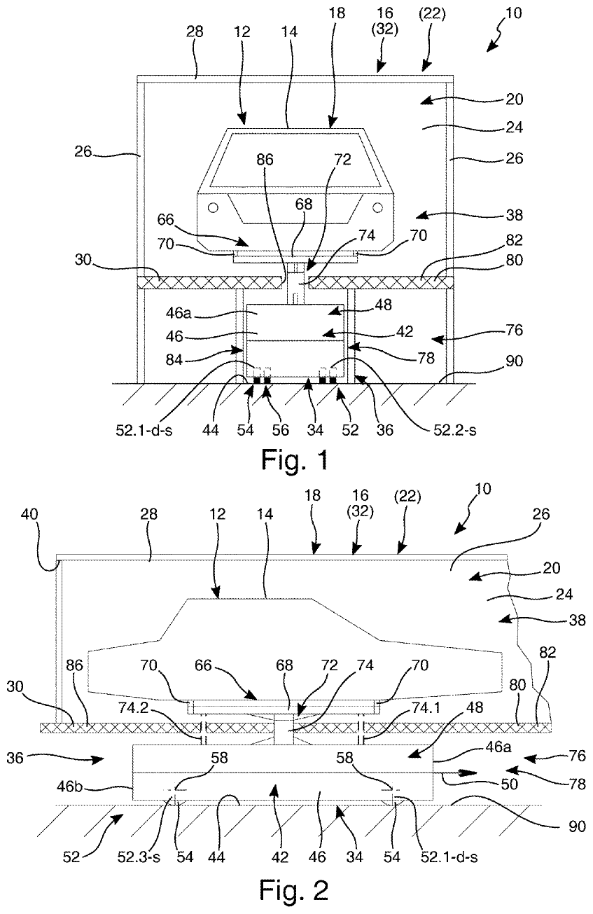

FIG. 1 shows schematically a cross section of a treatment plant with a conveying space which is connected by a connecting passage to a travel space, arranged below said conveying space, for a conveying system by means of which workpieces are conveyed on a conveying line, wherein the conveying system comprises a multiplicity of free-moving transport carts;

FIG. 2 shows a partial longitudinal section of the treatment plant according to FIG. 1 with a transport cart;

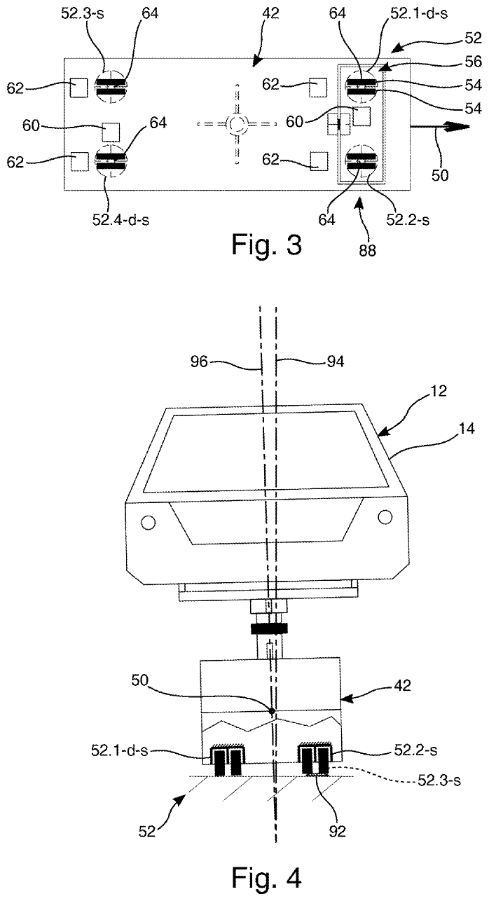

FIG. 3 shows a view from below of a chassis of a transport cart, wherein four wheel arrangements each having a pair of wheels are shown, and a wheel guiding system according to the invention is illustrated;

FIG. 4 shows a front view of a transport cart according to the prior art, in which the workpiece is tilted in relation to a vertical longitudinal plane when the transport cart travels over a floor unevenness;

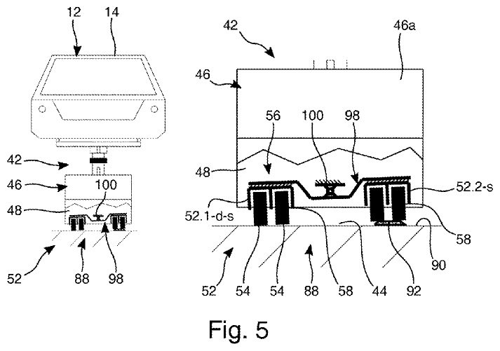

FIG. 5 shows a front view and a larger detailed view of a transport cart with a wheel guiding system according to a first exemplary embodiment in the region of a floor unevenness;

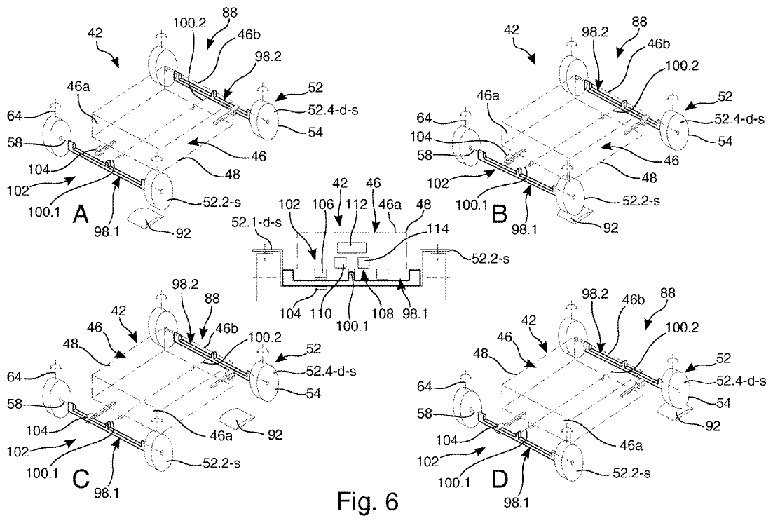

FIG. 6 shows a transport cart with a wheel guiding system according to a second exemplary embodiment, wherein a front view of the transport cart and four movement phases A, B, C, D during the overcoming of a floor unevenness are shown in a perspective view in each case;

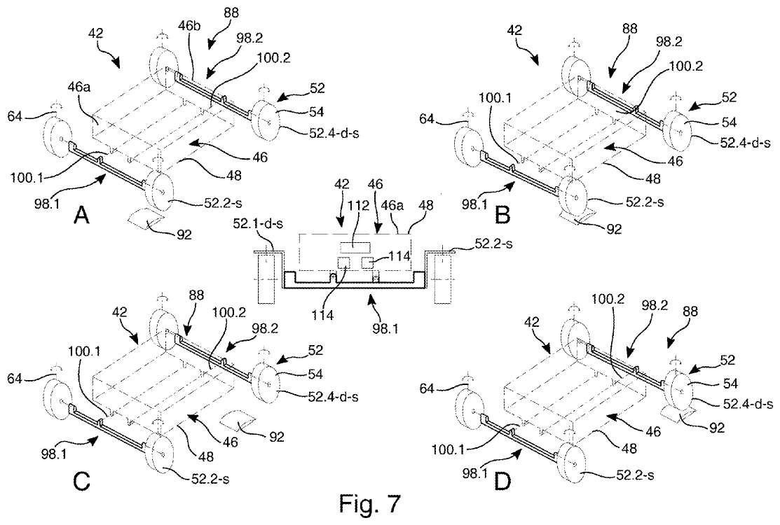

FIG. 7 shows a transport cart with a wheel guiding system according to a third exemplary embodiment, wherein a front view of the transport cart and four movement phases A, B, C, D during the overcoming of a floor unevenness are shown in a perspective view in each case;

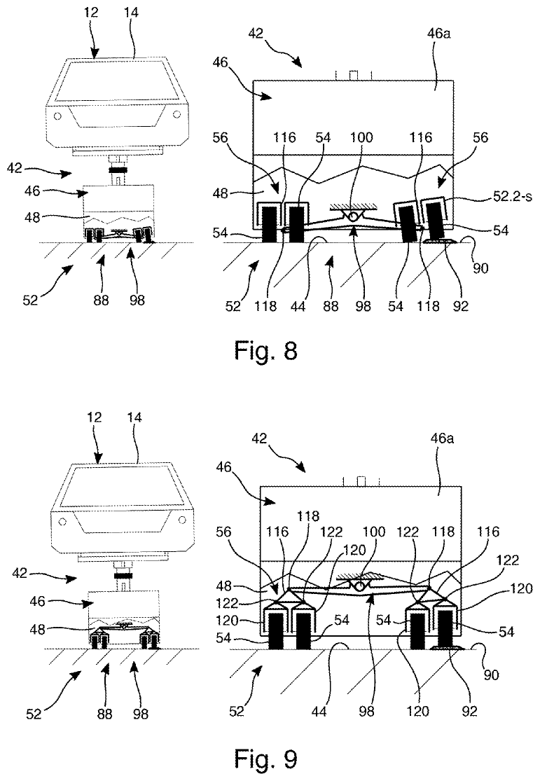

FIG. 8 shows a front view and a larger detailed view of a transport cart with a wheel guiding system according to a fourth exemplary embodiment in the region of a floor unevenness;

FIG. 9 shows a front view and a larger detailed view of a transport cart with a wheel guiding system according to a fifth exemplary embodiment in the region of a floor unevenness.

### DESCRIPTION OF PREFERRED EXEMPLARY EMBODIMENTS

FIGS. 1 and 2 schematically illustrate a treatment plant, denoted overall by 10, for treating workpieces 12 which are illustrated by way of example as vehicle bodies 14.

The treatment plant 10 comprises a treatment device 16 with a housing 18 which defines a treatment space 20. The treatment device 16 can also be a workstation 22 in which assembly operations, quality control operations or the like are undertaken and in which the treatment space 20 can be open upward and optionally open on all sides.

However, the invention will be explained below using the example of a treatment device 16 in which the treatment space 20 is designed as a treatment tunnel 24 and comprises two tunnel walls in the form of sidewalls 26 and two further tunnel walls in the form of a ceiling 28 and a floor 30. Irrespective of its specific design, i.e. whether open or closed, the treatment space 20 in all cases has a floor 30. Even in the case of a treatment space 20 closed in this way, the treatment device 16 can be a workstation 22.

Such a treatment device 16 with tunnel walls 26, 28 and 30 is in particular a dryer 32, in which the treatment tunnel 24 predefines a dry tunnel. However, such a treatment device 16 may also be a treatment device with a corresponding treatment tunnel in which the workpieces 12 are painted in particular automatically with the aid of painting robots which guide an application device, or manually.

The workpieces 12 are conveyed with a conveying system 34 on a conveying line 36 through the treatment space 20, i.e. here the treatment tunnel 24 of the treatment device 16, and also outside the treatment device 16. In the latter case, for example, between two treatment devices 16 which are present along the conveying line 36, or on the path toward the treatment plant 10 or on the path away from the treatment plant 10.

Along the conveying line 36, the workpieces 12 thus move in a conveying space 38 above the floor 30 which extends at least in sections along the conveying line 36. The floor 30 can also be present in front of and/or behind treatment devices 16 which are present in each case. In the region of the treatment device 16, the conveying space 38 coincides with the treatment space 20 thereof. Accordingly, the conveying space 38 can likewise be opened or closed.

The conveying line 36 can comprise one or more curved sections, wherein a curved section can be present in the region of and/or outside the treatment device 16.

The treatment device 16 is operated continuously and accordingly has an input at one end side and an output at the opposite end side, of which only the input is denoted by 40 in FIG. 2. The input 40 and the output can be designed as a lock, as is known per se and in itself. However, the treatment space 20 can also be configured as a batch system and can optionally only have a single entrance via which the workpieces 12 are conveyed into the treatment space and are also conveyed again out of the latter after the treatment. This single entrance can also optionally be designed as a lock.

The conveying system 34 comprises a multiplicity of free-moving transport carts 42 on which the workpieces 12 are transported and which move on a travel floor 44. The transport carts 42 are floor-based and are designed as free-moving transport vehicles in the sense of driverless transport systems that are familiar to a person skilled in the art as what are referred to as DTSs. The transport carts 42 are drivable and steerable independently of one another.

The terms horizontally and vertically that are used here always relate to the transport vehicle 42 when the latter is completely ready for operation and travel on a horizontal and flat section of the travel floor 44.

Each transport cart 42 comprises a chassis 46 with a chassis frame 48 which defines a main axis, shown by an arrow 50, and main orientation of the transport cart 42. In the exemplary embodiment here, the main axis 50 is the longitudinal axis and is also referred to below as longitudinal axis 50. In the main orientation following therefrom, the chassis 46 has a front 46a and a corresponding rear 46b. The main orientation is oriented, in general terms, on the basis of the direction in which the transport vehicle 42 moves forward. To this end, a corresponding front 42a can be assigned even to omnidirectional transport carts 42.

The chassis frame 48 supports at least four wheel arrangements 52 which can be seen in FIG. 3 and are denoted there by 52.1, 52.2, 52.3 and 52.4.

Each wheel arrangement 52 comprises one or more wheels 54 and can consequently have one individual wheel 54 or can comprise a pair of wheels 56 consisting of two wheels 54 or else more than two wheels 54. Each wheel 54 which is present is rotatable about a wheel axis 58 assigned to the respective wheel 54. If two or more wheels 54 are present, they are arranged, in a wheel arrangement 52, at least axially parallel with respect to the wheel axes 58. The wheels 54, the pairs of wheels 56 and the wheel axes 58 are not provided in all the figures and are not always all provided with reference signs.

The term “wheel” should be understood as meaning also rollers or rolls or the like and, in particular in the case of omnidirectional transport carts 42, also omni wheels or Mecanum wheels or the like.

A wheel arrangement 52 can be driven and can therefore propel the transport cart 42. If a driven wheel arrangement 52 is intended to be denoted in the figures, said wheel arrangement bears the additional index “-d” from the word “drive”.

For this purpose, the driven wheel arrangement 52-d, depending on the configuration, correspondingly comprises one or more driven wheels 54. If a driven wheel arrangement 52-d comprises more than one wheel 54, it can suffice if only one of said wheels 54 of the wheel arrangement 52-d is driven. The driven wheel or wheels 54 of a driven wheel arrangement 52-d is or are coupled to a drive device 60, which is shown schematically only in FIG. 3.

In addition, a wheel arrangement 52 can be steerable and can therefore change the direction of movement of the transport cart 42. If a steerable wheel arrangement 52 is intended to be referred to in the figures, it bears the additional index “-s” from the word “steer”. A driven and steerable wheel arrangement is thus denoted by 52-d-s.

For this purpose, in the case of the present exemplary embodiment, the steerable wheel arrangement 52-s is rotatable with the aid of a steering device 62, likewise shown only in FIG. 3, about a steering axis of rotation 64 which runs vertically when the transport cart 42 rests with its wheel arrangements 52 on a horizontally flat section of the travel floor 44.

In practice, individual wheels 54 are also drivable separately and are each coupled to a dedicated drive device 60. If a plurality of separately driven wheels 54 are present in a wheel arrangement 52, the steering movement can be achieved in a manner known per se and in itself in that said wheels 54 are rotated with different directions of rotation and/or rotational speeds about their wheel axis 58. In this case, there are therefore no driving and steering devices 60 and 62 that are separate from one another.

Both the driving device 60 and the steering device 62 operate in practice with electric motors which are coupled directly or via transmission elements to the wheel arrangement 52 or to an associated wheel 54.

In the present exemplary embodiment, the transport cart 42 is formed omnidirectionally, and therefore all of the wheel arrangements 52-s are steerable in this manner. If, as discussed above, omni wheels or Mecanum wheels are used, the rotation about the steering axis of rotation 64 can be omitted. The steering device 62 then coordinates, for example, the wheel activations necessary for the change in direction.

In the present exemplary embodiments, four wheel arrangements 52 are provided, in each case one at the front on the left and right and at the rear on the left and right in the direction of the longitudinal axis 50. Two drivable and steerable wheel arrangements 52-d-s are provided here diagonally at the front on the right and at the rear on the left; alternatively, wheel arrangements 52-d-s can also be provided at the front on the right and at the rear on the left. The two other wheel arrangements 52-s are merely steerable. However, four driven and steerable wheel arrangements 52-d-s can also be provided.

Specifically, in FIG. 3, according to the above-explained terminology, the wheel arrangements 52 are denoted by 52.1-d-s, 52.2-s, 52.3-s and 52.4-d-s, with the view from below being taken into consideration there.

In the case of modifications which are not shown by themselves, non-steerable wheel arrangements 52 can also be present, for example two front wheel arrangements 52-d-s in the direction of the longitudinal axis 50 can be driven and steerable and two rear wheel arrangements 52 in the direction of the longitudinal axis 50 can be non-driven and non-steerable.

In the case of modifications which are likewise not shown separately, more than four wheel arrangements 52, in particular six, eight or ten wheel arrangements 52, can also be provided. The number and arrangement of driven and/or steerable and neither driven nor steerable wheel arrangements 52-d, 52-s, 52-d-s and 52 is coordinated here with the local conditions and requirements imposed on the conveying system 34.

The transport cart 42 comprises a fastening device 66 to which a workpiece 12 or a corresponding workpiece carrier for workpieces 12 can be fastened. For the fastening of vehicle bodies 14, the fastening device 62 in the present exemplary embodiment comprises a carrying profile 68 with bearing bolts 70 which cooperate in a manner known per se and in themselves with counter elements on the vehicle body 14 such that the vehicle body 14 can be fixed on the fastening device 66.

The fastening device 66 can also have a plurality of sets of such bearing bolts 70 which are adapted to different vehicle bodies 14 of different dimensions and configurations such that the fastening device 66 can be used flexibly for different types of vehicle body. The fastening device 66 therefore directly receives a vehicle body without the vehicle body 14 being fastened on a workpiece carrier, such as, for example, a skid which is known per se and in itself.

The chassis 46 of the transport cart 42 is coupled to the fastening device 68 by means of a connecting device 72. The connecting device 72 comprises at least one upwardly pointing strut 74. FIG. 2 illustrates on the one hand a connecting device 72 with a single such strut 74 and on the other hand a connecting device 72 with two struts 74.1 and 74.2 which are illustrated by dashed lines in FIG. 2. In the case of two such struts 74.1, 74.2, the stability is possibly increased in comparison to only one strut 70.

Each strut 70 which is present couples the chassis 46 of the transport cart 42 to the fastening device 68. In a further modification, more than two struts 70 can also be present. The transport cart will be described below with respect to the exemplary embodiment with the single strut 70; what is stated with regard thereto applies analogously to transport carts 42 having a plurality of struts 70 or else differently designed connecting devices 72.

In the exemplary embodiment shown here, the strut 70 is at any rate shown as a rectilinear vertical strut, but may also have geometries differing therefrom. In particular, geometries of the strut 70 with a C-shaped section or with a section which is inclined from below upward in relation to a vertical plane which is parallel to the longitudinal axis 50 and to the transport direction are considered here.

The treatment plant 10 and the conveying system 34 are coordinated with one another in such a manner that only part of the conveying system 34 is moved in the conveying space 38 while the other part of the conveying system 34 is moved outside the conveying space 38.

For this purpose, outside the conveying space 38, a guiding region 76 with a travel space 78 likewise arranged outside the conveying space 38 is provided, in which the chassis 46 of a respective transport cart 42 is moved, wherein the conveying space 38 and the guide region 76 and the travel space 78 are upwardly separated by a partition 80. In the present exemplary embodiment, this partition 80 is a section 82 of the floor 30, wherein the guiding region 76 with the travel space 78 is arranged below the floor 30.

An arrangement of the guiding region 76 and of the travel space 78 “outside” the conveying space 38 should be understood in such a manner that there is a structural separation between the conveying space 38 and the guiding region 76 and the travel space 78 by means of the partition 80 which has been discussed. However, this does not mean that the guiding region 76 and optionally the travel space 78 cannot protrude at least in regions into the conveying space 38 and can overlap in cross section with the conveying space 38 and optionally with the treatment space 20.

The travel space 78 can be open toward the surroundings of the treatment device 16 or of the remaining conveying line 36; at any rate, there does not have to be a dedicated housing for the travel space 78. In the present exemplary embodiment, the travel space 78 is, however, bounded, at least in the region of the treatment device 16, by a dedicated travel space housing 84 which comprises the partition 80. In other words, in the present exemplary embodiment, the section 82 of the floor 80 is therefore part of the travel space housing 84. Alternatively, in the case of the treatment device 16, the sidewalls 26 of the housing 18 can also extend downward beyond the floor 30 such that they laterally bound the travel space 78 there; in this case, said travel space 78 is then upwardly separated from the treatment space 20 by the entire floor 30.

The travel space 78 is now connected to the conveying space 38 via a connecting passage 86 in the partition 80. The connecting passage 86 is complementary with respect to the connecting device 72 of the transport carts 42.

The connecting device 72 extends through the connecting passage 86 such that the fastening device 66 together with the workpiece 12 is located in the conveying space 38—and therefore in the treatment space 20 in the treatment device 16—and the chassis 46 of a transport cart 42 is located in the travel space 78.

In the present exemplary embodiment, the connecting passage 86 is consequently rectilinear in cross section. In the case of the above-discussed modifications of the struts 70, the connecting passage 86 is correspondingly angled and designed in the manner of a labyrinth in cross section. In the case of differently designed struts 70 or a connecting device 72 conceived differently once again, the connecting passage 86 is correspondingly adapted thereto. The flow path between the conveying space 38 and the travel space 78 can be shielded by shielding elements, such as, for example, laminae or the like arranged in imbricated form.

There is a preferably unsprung wheel guiding system 88 for the wheels 54 of the wheel arrangements 52. The wheel guiding system 88 defines a basic chassis configuration in which the wheel arrangements 52 define a horizontal travel plane 90. In said basic chassis configuration, the wheel axes 58 of the wheels 54 of the wheel arrangements 52 run horizontally. If the travel floor 44 is horizontally flat, the travel plane 90 coincides with the travel floor 44, as FIGS. 1 and 2 show. In FIG. 3, the travel plane 90 is the plane of the paper.

FIG. 4 first of all illustrates a situation in which an unsprung transport cart 42, without a further compensating device, travels with a wheel arrangement 52, here the non-driven and steerable wheel arrangement 52.2-s, with a pair of rollers 56 over a floor unevenness, denoted by 92, of the travel floor 44. In such a situation, two undesirable effects are in focus:

Firstly, the chassis 46 of the transport cart 42 is with respect to a vertical reference plane 94 which tilts laterally in the direction of the longitudinal axis 50 of the transport cart 42. This is illustrated by a comparison plane 96 which runs through the longitudinal axis 50 of the transport cart 42.

As can be seen, the floor unevenness 92 also causes the workpiece 12, in the present exemplary embodiment the vehicle body 14, to tilt in relation to the vertical reference plane 94.

Secondly, it may occur that a driven and steerable wheel arrangement 52-d-s loses contact with the travel floor 44 since the chassis 46 is raised by the floor unevenness 92. In FIG. 4, for example, the wheel arrangement 52.4-d-s, which lies behind the plane of the paper in FIG. 4 and is therefore indicated with a dashed reference line and which can be seen at the bottom on the left in the case of the transport cart 42 in FIG. 3, is lifted off the travel floor 44, and therefore no wheel 54 of the wheel arrangement 52.4-d-s has floor contact any more. The full driving and steering control for the transport cart 42 is lost at this moment.

This should already be avoided for a satisfactory process sequence since, in particular during a painting operation, the movement of the workpiece 12, i.e. here the vehicle body 14, and the movement of the application devices by the painting robots are coordinated with one another. A change in the planned movement of the workpiece through the treatment device 16 may therefore reduce the quality of the coating obtained.

Furthermore, it may occur, however, because of the two undesirable effects, firstly the tilting of the transport cart 42 and secondly the loss of the control of the movement of the transport cart 42, that the connecting device 72 of the transport cart 42 collides with the sidewall of the connecting passage 86. This may result in an extreme case in jamming of the system and in damage of the transport cart 42.

In order to counteract this, the wheel guiding system 88 guides the wheels 54 of the wheel arrangements 52 in such a manner that at least one wheel 54 of at least one wheel arrangement 52 is movable out of the travel plane 90, in particular because of a floor unevenness 92, without the remaining wheel arrangements 52 completely leaving the travel plane 90. This wheel 54 can therefore carry out a maximum movement out of the travel plane 90. The end of this movement is predefined by the construction if a further movement of said wheel 54 out of the travel plane 90 is mechanically stopped as it were.

By this means, it is possible that the wheels 54 which are not affected by the floor unevenness 92 do not lose contact with the travel floor 44. The control of the movement, i.e. the propulsion by the driving device 60 and the predetermined travel direction by the steering device 62, is thereby maintained for the transport cart 42, even in the event of floor unevennesses 92.

FIGS. 5 to 9 show preferred exemplary embodiments in which the wheel guiding system 88 comprises at least one swing-axle structure 98 which is mounted on the chassis frame 48 so as to swing about a swing axis 100 and which extends in the direction of the longitudinal axis 50 of the chassis 46 and in particular parallel thereto. The swing-axle structure 98 carries a first wheel arrangement 52 on the one side of the swing axis 100 and a second wheel arrangement 52 on the other side of the swing axis 100. In the present exemplary embodiment, these are the wheel arrangements 52.1-d-s and 52.2-s in the case of the swing-axle structures 98 in each case illustrated at the front 46a of the chassis 46, the corresponding reference signs not always being indicated again.

The swing axis 100 runs horizontally in practice in the basic chassis configuration, but may also be inclined upward or downward up to a certain degree in relation to a horizontal plane. In the basic chassis configuration, the swing axis 100 is arranged higher in the vertical direction than the wheel axes 58 of the wheels 54 that belong to the swing-axle structure 98.

In the case of the wheel guiding system 88 shown as the first exemplary embodiment in FIG. 5, there is a single swing-axle structure 98 which rigidly supports the two wheel arrangements 52. The swing axis 100 is arranged there on the swing-axle structure 98 centrally between the two wheel arrangements 52. The swing-axle structure 98 is shown by way of example at the front 46a of the chassis 46. By contrast, the other two wheel arrangements 52, i.e. at the rear 46b here, are coupled rigidly to the chassis frame 48 in said wheel guiding system 88.

Alternatively, the swing-axle structure 98 can be provided at the rear 46b and the wheel arrangements 52 coupled rigidly to the chassis frame 48 at the front 46a of the chassis frame 46.

A swing-axle structure 98 with two wheel arrangements 52 fastened rigidly thereto defines a system with a point of articulation, namely the swing axis 100.

If one of the two wheel arrangement 52 supported by the swing-axle structure 98, by way of example the wheel arrangement 52.2-s in FIG. 5, travels over a floor unevenness 92, the swing-axle structure 98 is deflected about the swing axis 100 and the wheels 54 of the wheel arrangement 52.2-s move upward out of the travel plane 90 with a vertical direction component.

The remaining wheel arrangements 52, i.e. the opposite wheel arrangement 52.1-d-s on the swing-axle structure 98 and the two wheel arrangements 52.3-s and 52.4-d-s at the rear 46b of the chassis 46, which wheel arrangements are located behind the plane of the paper in FIG. 5, remain in contact with the travel floor 44 and do not leave the travel plane 90. Only the opposite wheel arrangement 52.1-d-s on the swing-axle structure 98 tilts.

Of the pair of wheels 56 shown here in the case of the wheel arrangement 52.1-d-s, although the inner wheel 54 moves out of the travel plane 90, the outer wheel 54 remains in floor contact with the travel floor 44 and consequently the wheel arrangement 52.1-d-s does not leave the travel plane 90 completely, but rather only partially. The driving and steering control of the transport cart 42 via the wheel arrangement 52.1-d-s is maintained via the outer wheel 54.

Furthermore, even a lateral tilting of the workpiece 12 is at least reduced; there is substantially only a slight raising of the chassis 46 of the transport cart 42 in the front region and thereby also merely a slight raising of the workpiece 12.

If, however, during the further movement of the transport cart 42, the wheel arrangement 52.4-d-s at the rear 46b of the chassis 46 arrives at the floor unevenness 92, the chassis 46 is tilted since the wheel arrangements 52 at the rear 46b are coupled rigidly to the chassis frame 48.

FIG. 6 therefore shows, as a second exemplary embodiment, a wheel guiding system 88 which a first swing-axle structure 98.1, which is mounted on the chassis frame 48 so as to swing about a first swing axis 100.1, and a second swing-axle structure 98.2, which is mounted on the chassis frame 48 so as to swing about a second swing axis 100.2. The first and the second swing-axle structure 98.1, 98.2 are spaced apart from one another in the direction of the longitudinal axis 50 of the chassis 46. The chassis frame 48 is shown by dashed lines in FIG. 6. In addition, FIG. 6 illustrates wheel arrangements 52 having only a single wheel 54.

The wheel arrangements 52.1-d-s and 52.2-d are mounted rigidly on the swing-axle structure 98.1 at the front 46a of the chassis 46. The wheel arrangements 52.3-s and 52.4-d-s are mounted rigidly on the swing-axle structure 98.2 at the rear 46b of the chassis 46.

In both swing-axle structures 98.1, 98.2, the associated swing axis 100.1 or 100.2 is arranged on the swing-axle structure 98.1 or 98.2 centrally between the two wheel arrangements 52.

In the basis chassis configuration, the two swing axes 100.1 and 100.2 each extend parallel to the longitudinal axis 50 of the chassis 46 and lie at least in a common vertical plane, i.e. in the vertical reference plane 94 that is not shown in FIG. 6, but may be offset in the vertical direction. In the present exemplary embodiment, the first swing axis 100.1 and the second swing axis 100.2 run coaxially.

For each swing-axle structure 98, the wheel guiding system 88 comprises a blocking device 102 by means of which a swinging movement of the respective swing-axle structure 98 about the swing axis 100 can be blocked or released. For the two swing-axle structures 98.1 and 98.2, in the present exemplary embodiment there are consequently two blocking devices 102, of which, for the sake of clarity, only the blocking device 102 of the swing-axle structure 98.1 has been provided with reference signs and is explained.

In the present exemplary embodiment, the blocking device 102 comprises a movable blocking element 104 which is movable between a blocking position, in which it blocks a swinging movement of the swing-axle structure 98.1 or 98.2, and a release position, in which it releases a swinging movement of the swing-axle structure 98.1 or 98.2. The blocking element 104 is moved by a motor 106 which is shown only in the front view of the chassis 46.

In FIG. 6, the blocking element 104 is shown schematically as a fork which, in the blocking position, engages around a horizontal section of the swing-axle structure 98.1 or 98.2. However, configurations which are different therefrom are also conceivable, for example a bolt which, in its blocking position, can engage in an opening in the swing-axle structure 98, or a latch which, in its blocking position, can latch with a counter element on the swing-axle structure 98, or the like.

In addition, the wheel guiding system 88 comprises a safety device 108 which ensures that at least always one blocking element 104 of the two blocking devices 102 takes up its blocking position and blocks the associated swing-axle structure 98.1 or 98.2. Otherwise, i.e. if both blocking elements 104 of the two blocking devices 102 were to take up their release position at the same time, the chassis 46 would tilt unstably and about the swing axes 100.1 and 100.2 which are coaxial here.

For this purpose, the safety device 108 comprises a position sensor device 110 which is likewise shown only in the front view and which detects the position of the blocking elements 104 and interacts with a control device 112 which moves a blocking element 104 into the release position only when the respective other blocking element 104 takes up its blocking position.

In addition, the wheel guiding system 88 comprises a swing-sensor device 114 by means of which a swinging movement of each swing-axle structure 98.1 or 98.2 can be detected. The swing-sensor device 114 likewise interacts with the control device 112.

In the basic chassis configuration of the wheel guiding system 88, the swing-axle structure 98.1 at the front 46a of the chassis 46 is released and the swing-axle structure 98.2 at the rear 46b is blocked, as the movement phase A illustrates. During this movement phase A, the wheel arrangement 52.2-s, for example, now arrives at a floor unevenness 92 and, in the movement phase B, travels onto the floor unevenness 92.

In the process, the swing-axle structure 98.1 swings about its swing axis 100.1. This is basically the same situation that has been explained with regard to FIG. 5. During the further movement of the transport cart 42, the floor unevenness 92 is traveled over by the wheel arrangement 52.2-s and, in the movement phase C, the swing-axle structure 98.1 pivots back again; the wheel guiding system 88 is again in its basic chassis configuration.

The swinging movement of the swing-axle structure 98.1 during the travel over the floor unevenness is detected by the swing-sensor device 114 and transmitted to the control device 112. The control device 112 correlates the travel movement of the transport cart 42 and the swinging movement of the swing-axle structure 98.1; it can be deduced from the data that the floor unevenness 92 is now located between the wheel arrangement 52.2-s on the front swing-axle structure 98.1 and the wheel arrangement 52.4-d-s on the rear swing-axle structure 98.2.

The control device 112 now activates the motor 106 for the blocking element 104 of the front swing-axle structure 98.1 such that said blocking element is moved into its blocking position and blocks the front swing-axle structure 98.1, as the movement phase C in FIG. 6 illustrates. The blocking element 104 for the rear swing-axle structure 98.2 is then moved into its release position by the control device 112 correspondingly activating the motor 106; the movement phase C in FIG. 6 also shows this.

During the further movement of the transport cart 42, the rear swing-axle structure 98.2 can pivot about the swing axis 100.2 when the wheel arrangement 52.4-d-s travels onto the floor unevenness 92, as is shown in the movement phase C according to FIG. 6.

FIG. 7 shows, as a third exemplary embodiment, a modified wheel guiding system 88 with a first and a second swing-axle structure 98.1 and 98.2.

In a modification with respect to the exemplary embodiment according to FIGS. 5 and 6, the swing axes 100.1, 100.2 in the swing-axle structures 98.1, 98.2 are arranged eccentrically there on the swing-axle structure 98 between the two wheel arrangements 52. The distance between the swing axis 100 and one of the two wheel arrangements 52 is therefore greater than the distance between the swing axis 100 and the other of the two wheel arrangements 52.

The first and the second swing-axle structure 98.1 and 98.2 are mounted on the chassis frame 48 in such a manner that the swing axes 100.1 and 100.2 thereof in the basic chassis configuration are offset in a horizontal direction perpendicularly to the longitudinal axis 50. In the present exemplary embodiment, the two swing axes 100.1 and 100.2 therefore run parallel, but not coaxially. However, a non-parallel profile of the swing axes 100.1 and 100.2 is also possible.

This laterally offset mounting of the two swing-axle structures 98.1 and 98.2 means that the chassis 46 is stable for travel without further measures; the risk of tilting to the side, as would be the case in the exemplary embodiment according to FIG. 6 without the blocking elements 104, does not exist.

Accordingly, both on blocking elements 104 and on associated motors 106, the safety device 108 with sensor device 110, the control device 112 and the swing-sensor device 114 can be omitted.

In order nevertheless to detect floor unevennesses, it is possible to retain the swing-sensor device 114 and an associated control device 112 which, for example, can store the data and/or can forward same to a master central controller.

In the case of the exemplary embodiments according to FIGS. 5 to 7, the roller arrangements 52 are mounted rigidly on the swing-axle structures 98 and 98.1 and 98.2.

FIGS. 8 and 9 each show, as a fourth and fifth exemplary embodiment, a wheel guiding system 88 in which the wheel arrangements 52 are mounted movably on an associated swing-axle structure 98.

For this purpose, each wheel arrangement 52 comprises a carrying structure 116 which carries or supports the wheel 54 or the wheels 54 and which is in each case mounted on the swing-axle structure 98 so as to be pivotable about a pivot axis 118 which runs parallel to the swing axis 100 of the swing-axle structure 98.

Accordingly, the wheel arrangements 52, which can be seen in FIG. 8, of the wheel guiding system 88 are each mounted on the swing-axle structure 98 so as to be pivotable about a pivot axis 118. In the present exemplary embodiment, the pivot axes 118 are arranged lower in the vertical direction, in the basic configuration of the chassis of the wheel guiding system 88, than the swing axis 100 of the swing-axle structure 98. In the present exemplary embodiment, the pivot axes 118 of the wheel arrangements 52, in the basic chassis configuration of the wheel guiding system 88, are also arranged lower in the vertical direction than the wheel axes 58 of the one or more associated wheels 54 of the respective movably mounted wheel arrangement 52.

A swing-axle structure 98 with two wheel arrangements 52 fastened thereto about a respective pivot axis 118 defines a system with three joints or points of articulation, namely the swing axis 100 and the two pivot axes 118.

As FIG. 8 illustrates, a wheel arrangement 52, here the front wheel arrangement 52.2-s, can deviate with two degrees of freedom when it travels onto a floor unevenness 92. This is advantageous in particular when one pair of wheels 56 is used, if only one of the two wheels 54 of the pair of wheels 56 travels onto a floor unevenness 92.

Each wheel arrangement 52 can again have only one single wheel 54. If the wheel arrangement 52 comprises a plurality of wheels 54, as is shown in FIG. 8 using the example of two wheels 54 in each case, the spatial arrangement and spatial relationship of the wheels 54 of a wheel arrangement 52 with respect to one another does not change and therefore moves conjointly if the wheel arrangement 52 is tilted as a whole about the pivot axis 118.

The wheel arrangement 52, and thus the pair of wheels 56, can firstly pivot about the pivot axis 118 in such a manner that one of the wheels 54 of the pair of wheels 56 still remains in the travel plane 90 and only the other wheel 54 of the pair of wheels 56 travels over the floor unevenness 92. In the process, the swing-axle structure 98 undergoes a slight swinging movement about the swing axis 100.

The chassis 46 is raised less here than in the case of a swing-axle structure 98 with a rigid mounting of the wheel arrangements 52. The workpiece 12 can thereby be guided even more quietly and with a more stable movement over floor unevennesses 92.

In the case of the wheel guiding system 88 according to FIG. 9, a wheel arrangement 52 comprises a plurality of wheels 54, with again two wheels 54 as a pair of wheels 56 for each wheel arrangement 52 being shown by way of example.

In this wheel guiding system 88, the spatial arrangement and spatial relationship of the wheels 54 of a wheel arrangement 52 can change with respect to one another. For this purpose, each wheel 54 is once again mounted separately by means of a bearing structure 120 which, for its part, is fastened to the carrying structure 116 so as to be pivotable about a pivot axis 122, said pivot axes running parallel to the swing axis 100 of the swing-axle structure 98 and to the pivot axes 118 of the carrying structures 116 of the wheel arrangements 52.

In the case of the exemplary embodiment shown in FIG. 9, the pivot axes 122 of the bearing structures 120 in the case of a wheel arrangement 52 in the basic chassis configuration of the wheel guiding system 88 are arranged lower in the vertical direction than the pivot axis 118 of the carrying structure 116 and are located in a common horizontal plane. The pivot axes 112 of the bearing structures 120 in the case of a wheel arrangement 52 in the basic chassis configuration are arranged here in the vertical direction between the pivot axis 118 of the supporting structure 116 and the wheel axes 58 of the wheels 54 of the wheel arrangement 52. In a horizontal direction, the two pivot axes 122 of the bearing structures 120 are arranged on either side of a vertical plane which runs through the pivot axis 118 of the carrying structure 116. The pivot axis 118 of the carrying structures 116 of the wheel arrangement 52 is arranged at approximately the same height as the swing axis 100 in the basic chassis configuration.

If then, in the case of one pair of wheels 56 with two wheels 54 in a wheel arrangement 52, one of the wheels 54 travels onto a floor unevenness 92, the carrying structure 116 of the wheel arrangement 52 and the two bearing structures 120 of the wheels 54 can pivot in opposite directions about the respective pivot axes 118 and 122. It is thereby possible for the wheel axes 58 of the wheels 54 to run horizontally despite the floor unevenness 92 and for the wheels 54 not to tilt with respect to a horizontal plane.

In the variants according to FIGS. 8 and 9, in each case there can be again only one swing-axle structure 98, as has been described in conjunction with FIG. 5, or there can be in each case a front and a rear swing-axle structure 98.1, 98.2, as has been explained in conjunction with FIGS. 6 and 7; in the case of two swing-axle structures 98.1, 98.2, the respective swing axes 100.1, 100.2 can therefore run alternatively in one and the same vertical plane and also coaxially with respect to one another, as shown in FIG. 6, or can be offset in a direction perpendicular to such a plane, as FIG. 7 illustrates.

In all the above-explained exemplary embodiments, the respective load which is removed to the travel floor 44 by a certain wheel arrangement 52 remains substantially unchanged when a floor unevenness 92 is traveled over. The only small influences thereon by the reduced tilting of the chassis 46 or of the workpiece 12 to the side or in the transport direction are not taken into consideration here.

In all the above-explained exemplary embodiments, the wheel guiding system 88 leads thereto and is configured in such a manner that the transport cart 42 always remains statically determined within the scope of the possible movement of the wheel 54 or of one of the wheel arrangements 52 out of the travel plane 90. By this means, it is consequently prevented that the transport cart 42 can wobble in relation to the travel floor 44 within the meaning of a static underdeterminedness. Therefore, only if a floor unevenness 92 leads to a wheel arrangement 52 having to be moved further out of the travel plane 90 than the construction permits is the transport cart 42 raised in such a manner that the transport cart 42 is statically underdetermined and wobbles in relation to the travel floor 44.

What is claimed is:

1. A free-moving transport cart for conveying workpieces, comprising: having
a) a chassis which defines a main axis and main orientation of the transport cart, and comprises a chassis frame which supports a plurality of wheel arrangements each having one or more wheels;
b) a fastening device for at least one workpiece, which is coupled to the chassis by means of a connecting device;
c) a wheel guiding system for the one or more wheels of the plurality of wheel arrangements, which defines a basic chassis configuration in which the plurality of wheel arrangements define a horizontal travel plane,
wherein
d) the wheel guiding system guides the one or more wheels of the plurality of wheel arrangements in such a manner that at least one wheel of at least one wheel arrangement is movable out of the travel plane without the remaining wheel arrangements completely leaving the travel plane.

2. The transport cart as claimed in claim 1, wherein the wheel guiding system comprises at least one swing-axle structure which is mounted on the chassis frame so as to swing about a swing axis and which extends in the direction of the main axis, wherein the swing-axle structure carries a first wheel arrangement from the plurality of wheel arrangements on the one side of the of the swing axis and carries a second wheel arrangement from the plurality of wheel arrangements on the other side of the swing axis.

3. The transport cart as claimed in claim 2, wherein the swing axis is arranged centrally between the first wheel arrangement and the second wheel arrangement.

4. The transport cart as claimed in claim 2, wherein the swing axis is arranged eccentrically between the first wheel arrangement and the second wheel arrangement.

5. The transport cart as claimed in claim 2, wherein the wheel guiding system comprises a first swing-axle structure and a second swing-axle structure which are spaced apart from each other in the direction of the main axis.

6. The transport cart as claimed in claim 5, wherein a first swing axis of the first swing-axle structure and a second swing axis of the second swing-axle structure run at least in a common vertical plane in the basic chassis configuration.

7. The transport cart as claimed in claim 5, wherein a first swing axis of the first swing-axle structure and a second swing axis of the second swing-axle structure are offset in a horizontal direction perpendicular to the main axis in the basic chassis configuration.

8. The transport cart as claimed in claim 2, wherein the wheel guiding system for at least one swing-axle structure which is present comprises a blocking device by means of which a swinging movement of the at least one swing-axle structure about the swing axis is blockable or releasable.

9. The transport cart as claimed in claim 8, wherein the blocking device comprises a movable blocking element which is movable between a blocking position, in which it blocks a swinging movement of the at least one swing-axle structure, and a release position, in which it releases a swinging movement of the swing-axle structure.

10. The transport cart as claimed in claim 9, wherein there is a respective blocking device with a blocking element for a first swing-axle structure and a second swing-axle structure, and in that the wheel guiding system comprises a safety device which ensures that at least always one blocking element of the respective blocking devices takes up its blocking position and blocks the associated swing-axle structure.

11. The transport cart as claimed in claim 2, wherein in the case of at least one swing-axle structure, the first wheel arrangement and/or the second wheel arrangement is mounted movably on the at least one swing-axle structure.

12. The transport cart as claimed in claim 11, wherein the movably mounted wheel arrangement comprises a carrying structure which carries or supports one or more wheels and is mounted on the at least one swing-axle structure so as to be pivotable about a pivot axis, wherein the pivot axis runs in particular parallel to the swing axis of the at least one swing-axle structure.

13. The transport cart as claimed in claim 12, wherein in the basic chassis configuration, the pivot axis of the carrying structure is located lower in the vertical direction than wheel axes of the one or more wheels of the movably mounted wheel arrangement.

14. The transport cart as claimed in claim 12, wherein the movably mounted wheel arrangement comprises at least one first wheel and at least one second wheel which are each mounted separately by means of a bearing structure which is in each case fastened pivotably about a pivot axis to the carrying structure, said pivot axes running parallel to the swing axis of the at least swing-axle structure and to the pivot axes of the carrying structures of the plurality of wheel arrangements.

15. The transport cart as claimed in claim 1, wherein the wheel guiding system is unsprung.

16. The transport cart as claimed in claim 1, wherein the wheel guiding system is configured in such a manner that, within the scope of the possible movement of the at least one wheel or of one of the wheel arrangements out of the travel plane, the transport cart always remains statically determined.

17. A conveying system for conveying workpieces on a conveying line, wherein characterized in that the conveying system comprises a multiplicity of transport carts as claimed in claim 1.

18. A treatment plant for treating workpieces having a conveying system for conveying the workpieces as claimed in claim 17.

19. The treatment plant as claimed in claim 18, wherein along the conveying line there is a travel space for the chassis, which is connected in an upward direction to a conveying space by a connecting passage in such a manner that the chassis is movable in the travel space and the fastening device is carried along in the conveying space, with the connecting device extending through the connecting passage.

20. The treatment plant as claimed in claim 19, wherein along the conveying line at least one treatment device is arranged which comprises a floor and/or a partition with the connecting passage.
